(19) United States
(12) Patent Application Publication
(10) Pub. No.: US 2017/0230870 A1
(43) Pub. Date: Aug. 10, 2017

(54) APPARATUS AND METHOD OF PERFORMING EFFICIENT DATA SERVICE SWITCH BETWEEN TWO SUBSCRIPTIONS IN DUAL SIM DUAL STANDBY DEVICES

(71) Applicant: QUALCOMM Incorporated, San Diego, CA (US)

(72) Inventors: Yongsheng SHI, San Diego, CA (US); Uttam PATTANAYAK, San Diego, CA (US); Shivank NAYAK, San Diego, CA (US); Abhishek BHATNAGAR, San Diego, CA (US); Debesh Kumar SAHU, Hyderabad (IN); Raja Rajeswari CHITIKE, Hyderabad (IN)

(21) Appl. No.: 15/019,691

(22) Filed: Feb. 9, 2016

(51) Int. Cl. H04W 36/00; H04W 60/06

(52) U.S. Cl. CPC H04W 36/0022; H04W 60/06; H04W 88/06

(57) ABSTRACT

A method for performing data service switch for a mobile communication device having a first subscription configured as a dedicated data subscription (DDS) and a second subscription includes: receiving a multimedia messaging service (MMS) message notification on the second subscription; calculating an approximate transfer time for receiving the MMS message; determining the that the approximate transfer time is less than a specified time; in response to determining that the approximate transfer time is less than the specified time, performing at the mobile communication device a local packet switched (PS) service detach procedure for the first subscription; performing a circuit switched (CS) service attach procedure for the first subscription; and performing a PS service attach procedure for the second subscription.

### BACKGROUND

A dual Subscriber Identity Module (SIM) dual standby (DSDS) mobile communication device may support one packet switched (PS) connection (i.e., a data connection) on one of the subscriptions at any time. FIG. 5 is a sequence diagram 500 illustrating typical multimedia messaging service (MMS) initiated dedicated data subscription (DDS) switch call flow. As illustrated in FIG. 5, a first subscription (Sub1) may be configured as a DDS with packet switched and circuit switched (PS+CS) service. For example, Sub1 may be configured with Long Term Evolution/Wideband Code Division Multiple Access/Global System for Mobile communications (LTE/WCDMA/GSM) capability and may be camped on LTE with PS+CS service. The CS service (i.e., voice call service) may be implemented by circuit-switched fall back (CSFB).

A second subscription (Sub2) may be configured with CS only service. For example, Sub2 may be configured with GSM only with CS service. If Sub2 receives an MMS message notification (i.e., a page), a DDS switch from Sub1 to Sub2 initiated by the MMS page may bring up a PS connection on Sub2 to receive the MMS message. Referring to FIG. 5, at block 510 with Sub1 configured as the DDS CS+PS subscription and Sub2 as the CS only subscription, reception of an MMS message notification on Sub 2 triggers a DDS switch from Sub1 to Sub2.

At block 515, Sub1 sends a PS Detach to the network and waits for a Detach Accept to release the PS domain. This duration is typically 1 to 2 seconds and may be longer. At block 520, after Sub1 releases the PS domain, the mobile communication device may search for CS service on Sub1 for WCDMA or GSM and also start performing a PS service attach procedure on Sub2.

At block 525, since LTE was just released on Sub 1, Sub1 performs an acquisition procedure, including band scan, to find WCDMA or GSM service. At the same time, Sub2 performs a PS service attach procedure. In a DSDS mobile communication device there is only one radio frequency (RF) resource, i.e., an RF chain (e.g., transceiver, antenna, etc.) so Sub1 and Sub2 cannot perform their procedures simultaneously. Accordingly, Sub2 may get control of the RF chain first and perform the PS service attach procedure. This duration is typically 2 to 3 seconds and may be longer. While Sub2 performs the PS service attach procedure, Sub1 is in an out-of-service (OOS) state.

At block 530, after Sub2 completes the PS service attach procedure, Sub1 may get control of the RF chain to continue acquisition and the CS service attach procedure. In a worst case, Sub2 may maintain control of the RF chain to perform MMS message reception. In this case, Sub1 will still be in the out-of-service (OOS) state until it gets control of the RF chain. This duration can last long a long time depending on the size of the MMS message. At block 535, after Sub1 completes the CS service attach procedure, Sub1 can return to CS service and Sub2 is able to receive the MIMS message. Tune away from sub2 to Sub1 will allow Sub1 to receive CS pages.

At block 540, after MMS reception, the DDS is switched back to Sub 1. At block 545, Sub 2 sends a PS Detach message to the network and waits for a Detach Accept message to release the PS domain. The duration is typically 1 to 2 seconds and can be longer. At block 550 a PS service attach procedure is triggered at Sub 1. At block 555, Sub1 performs the PS service attach procedure. The duration is typically 2 to 3 seconds and can be longer.

Referring to FIG. 5, the overall delay in resuming voice call service resulting from MMS reception and/or transmission may be large. For Sub2 to receive/send an MMS message, the PS domain is moved between Sub1 and Sub2 resulting in several over-the-air (OTA) messages. The overhead associated with the PS detach for Sub1 and the PS service attach procedure for Sub2 may result in a delay longer than 10 seconds and in some cases more than 25 seconds. In addition, the CS service on Sub1 may be interrupted due to the PS service attach procedure and MMS reception or transmission on Sub2.

Some network operators may support MMS messages up to a maximum size of 5 megabits (MB). The overall delay for large MMS message reception or transmission may be large. For a 5 MB MMS message, a general packet radio service (GPRS) network may take more than five seconds to retrieve the MMS message and even longer to receive a group MMS message. For Sub2 to receive/transmit an MMS message, the PS domain switches between the two subscriptions resulting in several OTA messages between the mobile communication device and the communication networks (e.g., at operations 2 and 8). The delay in resuming voice call service caused by the overhead of the OTA messages when performing a PS detach for Sub1 and a PS service attach procedure for Sub2, and vice-versa after MMS message reception, can be large resulting in CS service interruption.

Further, Sub 1 may be an LTE subscription with voice over LTE (VoLTE) enabled. If the MMS message is large (e.g., around 5 MB) and if the SIM2 network is a GPRS network, MMS message reception may take on the order of five minutes. If the mobile communication device has performed a local PS detach procedure (i.e., the mobile communication device did not inform the IP Multimedia Subsystem (IMS) core network of the PS detach), incoming VoLTE calls for SIM1 will fail during the time used for MMS message reception.

For example, after performing a local PS detach procedure for Sub1 on SIM1, if there is an incoming call for SIM1 during an MMS transfer on SIM2, the IMS server cannot reach SUB1 (i.e., the LTE subscription). The network will send a SIP INVITE, but the UE cannot receive the SIP INVITE since DDS is switched to SIM2 and SIM2 controls the RF chain. The IMS server may resend the SIP INVITE within a time limit defined by a SIP INVITE Retry timer (e.g., 15-30 seconds). After the timer expires, the IMS server may notify the mobile switching center (MSC) about the call failure. In addition, the MSC cannot reach SIM1 since SIM1 is not registered through WCDMA. Accordingly, a call setup failure may occur. Once the MMS download ends, the mobile communication unit may switch the DDS back to SUB1, perform the PS service attach procedure on SIM1, and SUB1 will then be reachable by the IMS server.

It is noted that it may take five seconds to switch the DDS switch back to SIM1, perform the PS service attach procedure on SIM1, etc. If the MMS message size is large (e.g., equal to or greater than 5 MB) and if the SIM2 network is a GPRS network, the MMS message transfer may take up to 5 minutes. If the mobile communication device performs a local PS detach procedure and does not inform the IMS core network, incoming VoLTE calls for SIM1 may fail for five minutes or longer.

### SUMMARY

Apparatuses and methods for performing data service switching are provided.

According to various aspects there is provided a method for performing data service switch for a mobile communication device having a first subscription configured as a dedicated data subscription (DDS) and a second subscription. In some aspects, the method may include: receiving a multimedia messaging service (MMS) message notification on the second subscription; calculating an approximate transfer time for receiving the MMS message; determining the that the approximate transfer time is less than a specified time; in response to determining that the approximate transfer time is less than the specified time, performing at the mobile communication device a local packet switched (PS) service detach procedure for the first subscription; performing a circuit switched (CS) service attach procedure for the first subscription; and performing a PS service attach procedure for the second subscription.

According to various aspects there is provided a mobile communication device having a first subscription configured as a dedicated data subscription (DDS) and a second subscription. In some aspects, the mobile communication device may include: a radio frequency (RF) chain; and a control unit.

The control unit may be configured to: control the RF chain to receive a multimedia messaging service (MMS) message notification on the second subscription via the RF chain; calculate an approximate transfer time for receiving the MMS message; determine that the approximate transfer time is less than a specified time; in response to determining that the approximate transfer time is less than the specified time, the control unit is configured to perform at the mobile communication device a local packet switched (PS) service detach procedure for the first subscription; perform a circuit switched (CS) service attach procedure for the first subscription; and perform a PS service attach procedure for the second subscription.

According to various aspects there is provided a non-transitory computer readable medium having stored therein a program for causing one or more processors to execute a method for performing data service switch for a mobile communication device having a first subscription configured as a dedicated data subscription (DDS) and a second subscription. In some aspects, the non-transitory computer readable medium may include instructions for causing one or more processors to perform operations including: receiving a multimedia messaging service (MMS) message notification on the second subscription; calculating an approximate transfer time for receiving the MMS message; determine that the approximate transfer time is less than a specified time; in response to determining that the approximate transfer time is less than the specified time, performing at the mobile communication device a local packet switched (PS) service detach procedure for the first subscription; performing a circuit switched (CS) service attach procedure for the first subscription; and performing a PS service attach procedure for the second subscription.

According to various aspects there is provided a mobile communication device having a first subscription configured as a dedicated data subscription (DDS) and a second subscription. In some aspects, the mobile communication device may include: means for receiving a multimedia messaging service (MMS) message notification on the second subscription; means for calculating an approximate transfer time for receiving the MMS message; means for determining the that the approximate transfer time is less than a specified time; in response to determining that the approximate transfer time is less than the specified time, means for performing at the mobile communication device a local packet switched (PS) service detach procedure for the first subscription; means for performing a circuit switched (CS) service attach procedure for the first subscription; and means for performing a PS service attach procedure for the second subscription

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device according to various embodiments;

FIG. 1B is a diagram illustrating a network environment for various embodiments;

FIG. 2 is a sequence diagram illustrating MMS-initiated DDS switch call flow according to various embodiments;

FIG. 3 is a flowchart illustrating a method of performing efficient data service switch according to various embodiments;

FIG. 4 is a portion of Table 8 from the MMS Functional Description specification (3GPP TS 23.140); and

FIG. 5 is a sequence diagram illustrating typical MMS-initiated DDS switch call flow.

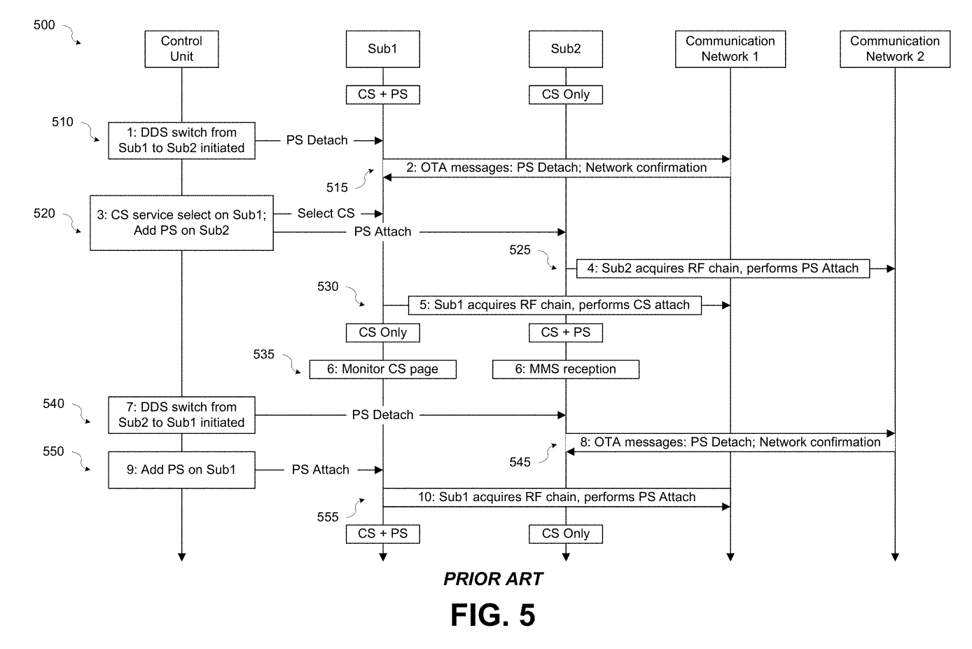

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

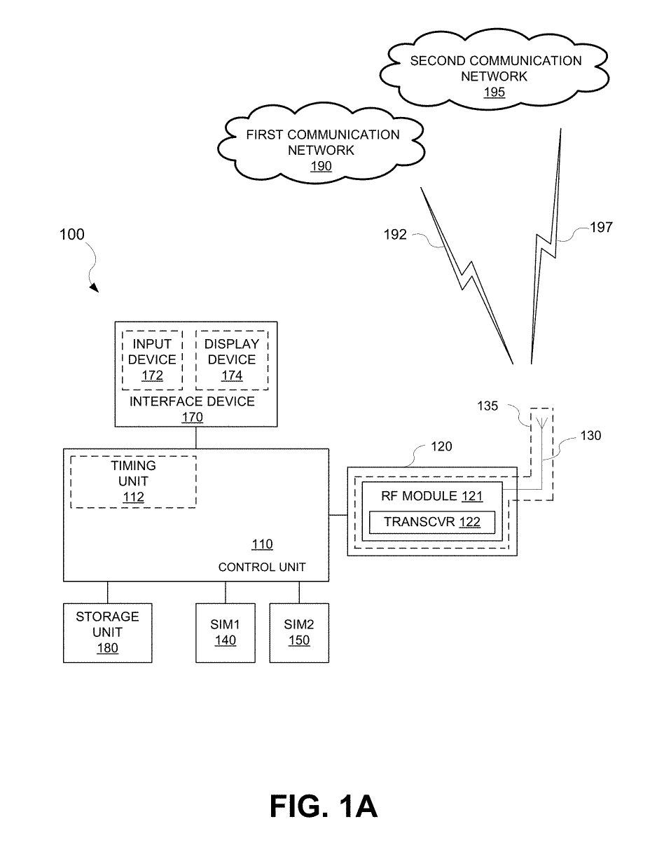

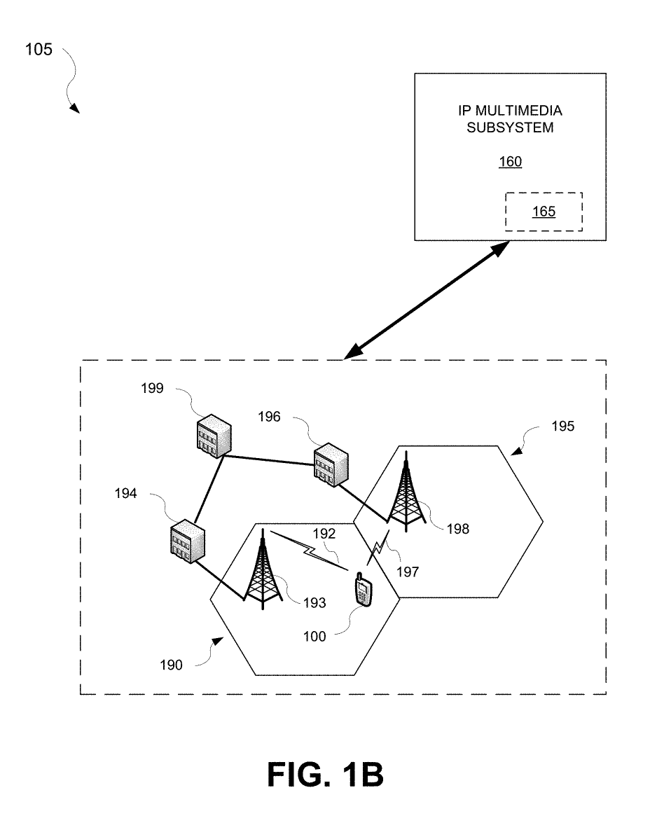

FIG. 1A is a block diagram illustrating a mobile communication device 100 according to various embodiments. As illustrated in FIG. 1, the mobile communication device 100 may include a control unit 110, a communication unit 120, an antenna 130, a first subscriber identity module (SIM) 140, a second SIM 150, a user interface device 170, and a storage unit 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communication units) and may interface with one or more antennas without departing from the scope of protection.

The communication unit 120 may include, for example, but not limited to, an RF module 121. The RF module 121 may include, for example, but not limited to the transceiver 122. An RF chain 135 may include, for example, but not limited to the antenna 130 and the RF module 121.

One of ordinary skill in the art will appreciate that embodiments of the mobile communication device 100 may include more than one communication unit and/or more than one antenna without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub 1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various embodiments are described in terms of DSDS mobile communication devices. However, one of ordinary skill in the art will appreciate that the various embodiments may be extended to Multi-SIM Multi-Standby (MSMS) mobile communication devices without departing from the scope of protection.

The first communication network 190 and the second communication network 195 may be operated by the same or different service providers, and/or may support the same or different RATs, for example, but not limited to, LTE, GSM, CDMA, and wideband CDMA (WCDMA).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the user interface device 170, and the storage unit 180. The control unit 110 may be a programmable device, for example, but not limited to, a microprocessor (e.g., general-purpose processor, baseband modem processor, etc.) or microcontroller.

The control unit 110 may include a timing unit 112 configured to provide a timer. Alternatively, the timing unit 112 may be implemented as electronic circuitry separate from the control unit 110.

The storage unit 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be an LTE network and the first subscription 192 may be an LTE subscription. The second communication network 195 may be a GSM network and the second subscription 197 may be a GSM subscription. Alternatively, the first communication network 190 and/or the second communication network 195 may implement another RAT including, for example, but not limited to, LTE, WCDMA, and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. The one or more BTSs (e.g., the first BTS 193) in the first communication network 190 may communicate with and be controlled by a first base station controller (BSC) 194.

The one or more BTSs (e.g., the second BTS 198) in the second communication network 195 may be controlled by a second BSC 196. The BSCs 194, 196 may allocate radio resources to mobile calls and handovers between the one or more BTSs under control of the BSC. The first BSC 194 and the second BSC 196 may communicate with a mobile switching center (MSC) 199. The MSC 199 may provide GSM/CDMA service, for example, but not limited to, routing voice calls and short message service (SMS), and other services (e.g., circuit switched data).

A person having ordinary skill in the art will appreciate that the network environment 105 may include any number of communication networks, mobile communication devices, BTSs, BSCs, and MSCs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

The mobile communication device 100 may also communicate with an Internet Protocol (IP) Multimedia Subsystem (IMS) server 165 in an IMS 160 via the first subscription 192 and/or the second subscription 197.

### Apparatus and Method of Performing Efficient Data Service Switch Between Two Subs in DSDS Devices

Much of the delay in resuming voice call service resulting from PS detach and PS service attach procedures during a DDS switch may be due to OTA messages being exchanged between the mobile communication device 100 and the network (e.g., the first communication network 190 and/or the second communication network 195). If the DDS switch is triggered by user selection, the PS service detach and attach procedures may be used because the mobile communication device 100 may stay on one PS domain for a long time. However, if the DDS switch from Sub1 192 to Sub2 197 is triggered by an MMS message notification, the DDS may be switched back to Sub1 after reception of the MMS message is completed. A typical MMS message reception uses a few seconds. Therefore, for typical MMS message reception it may not be necessary to send OTA messages to inform the network about PS domain detach.

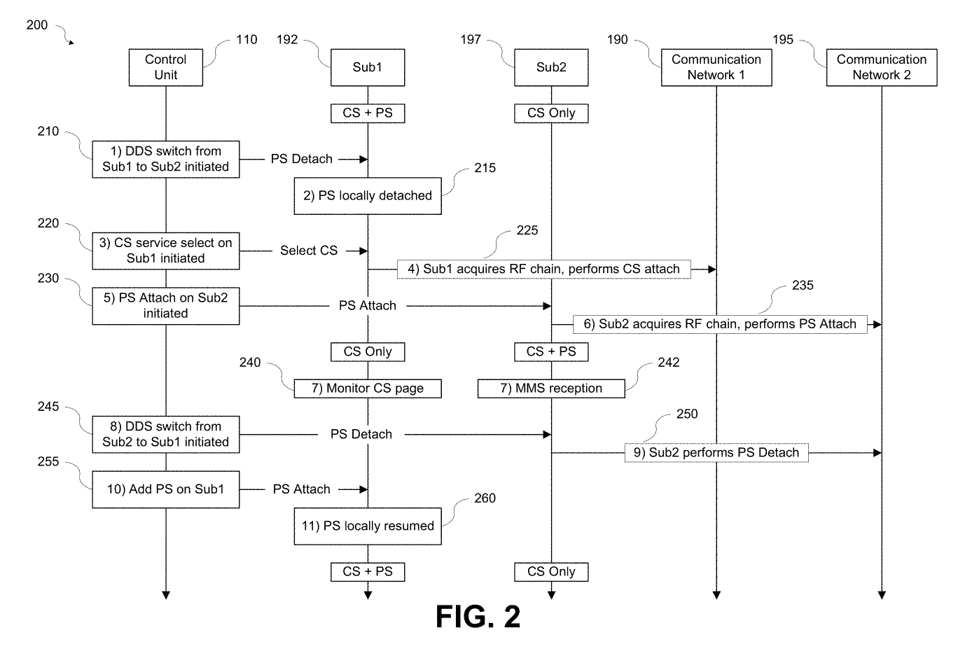

FIG. 2 is a sequence diagram 200 illustrating MMS-initiated DDS switch call flow according to various embodiments in which Sub1 192 performs local PS service detach and attach procedures. That is, Sub1 192 may locally suspend the PS domain when the DDS is switched by reception of an MMS message notification on Sub2 197 and may resume the PS domain after the DDS is switched back to Sub1 192. Performing local PS service detach and attach procedures may reduce delay by avoiding OTA messaging between the mobile communication device 100 and the network (e.g., the first communication network 190).

As illustrated in FIG. 2, a first subscription (Sub 1) 192 may be configured as a DDS with packet switched and circuit switched (PS+CS) service. For example, Sub 1 192 may be configured with Long Term Evolution/Wideband Code Division Multiple Access/Global System for Mobile communications (LTE/WCDMA/GSM) capability and may be camped on LTE with PS+CS service. The CS service (i.e., voice call service) may be implemented by circuit-switched fall back (CSFB).

A second subscription (Sub2) 197 may be configured with CS-only service. For example, Sub2 197 may be configured with GSM with only CS service. If Sub2 197 receives an MMS notification, or page, PS service on Sub2 197 may be initiated to receive the MMS message. At block 210, a DDS switch from Sub1 192 to Sub2 197 may be initiated by the MMS notification. At block 215, the PS service for Sub1 192 may be locally detached at the mobile communication device 100.

When the PS service for Sub1 192 is locally detached at the mobile communication device 100, the mobile communication device 100 does not send OTA messages to the corresponding communication network (e.g., the first communication network 190) to notify the corresponding communication network that the Sub1 PS service has been detached. Therefore, any additional delay time resulting from overhead for the OTA messaging is avoided.

After the PS service for Sub1 192 is locally detached, CS service selection for Sub1 192 may be initiated at block 220. At block 225, Sub1 may acquire the RF chain 135 and perform a CS service attach procedure with the corresponding communication network (e.g., the first communication network 190) by performing an acquisition procedure. At block 230, a PS service attach procedure for Sub2 197 may be initiated, and at block 235, Sub2 197 may acquire the RF chain 135 and perform the PS service attach procedure with the corresponding communication network (e.g., the second communication network 195).

In some embodiments, the CS service attach procedure for Sub1 192 may be completed before the PS service attach procedure for Sub2 197 is initiated. In one example, the control unit may wait for the CS service attach procedure to complete on Sub1 and then trigger the PS service attach procedure on Sub2. For example, the control unit 110 may cause the communication unit 120 to give control of the RF chain 135 to Sub1 192 to perform the CS service attach procedure. Upon completion of the CS service attach procedure, the control unit 110 may cause the communication unit 120 to give control of the RF chain 135 to Sub2 to perform the PS service attach procedure.

If Sub1 192 does not complete the CS service attach procedure, it may lose CS service while waiting for Sub2 197 to complete PS service attach procedure. This duration can be long if Sub2 197 maintains control of the RF chain to receive/transmit the MMS message after completing the PS service attach procedure. Allowing Sub1 192 to perform the CS service attach procedure does not affect CS service on Sub2 197.

In some embodiments, the CS service attach procedure for Sub1 192 may be initiated before the PS service attach procedure for Sub2 197 is initiated. For example, a timer (e.g., timing unit 112) may delay initiation of the PS service attach procedure for Sub2 197 to ensure that Sub1 192 gains control of the RF chain 135 to perform the CS service attach procedure prior to the PS service attach procedure for Sub2 197. By enabling the CS service attach procedure prior to the PS service attach procedure, interruption of the CS service may be minimized.

Thus, after the DDS switch Sub1 192 may be configured as the CS-only subscription capable of monitoring CS pages and/or conducting CS calls (i.e., voice calls), and Sub2 197 may be configured as the CS+PS DDS capable of receiving and/or transmitting MMS messages at blocks 240, 242.

Upon completion of MMS message reception, at block 245, a DDS switch from Sub2 197 to Sub1 192 may be initiated. At block 250, the PS service for Sub2 197 may be detached from the corresponding communication network (e.g., the second communication network 195). At block 255, the addition of PS service for Sub1 192 is initiated, and at block 260, the PS service for Sub1 192 is locally resumed at the mobile communication device.

When the PS service for Sub1 192 is locally resumed at the mobile communication device 100, the mobile communication device 100 does not send OTA messages to the corresponding communication network (e.g., the first communication network 190) to notify the corresponding communication network that the Sub1 PS service has been resumed. Therefore, any additional delay time resulting from overhead for the OTA messaging is avoided.

### Method to Improve VoLTE Incoming Call Performance on Sub1 During MMS Retrieval on Sub2

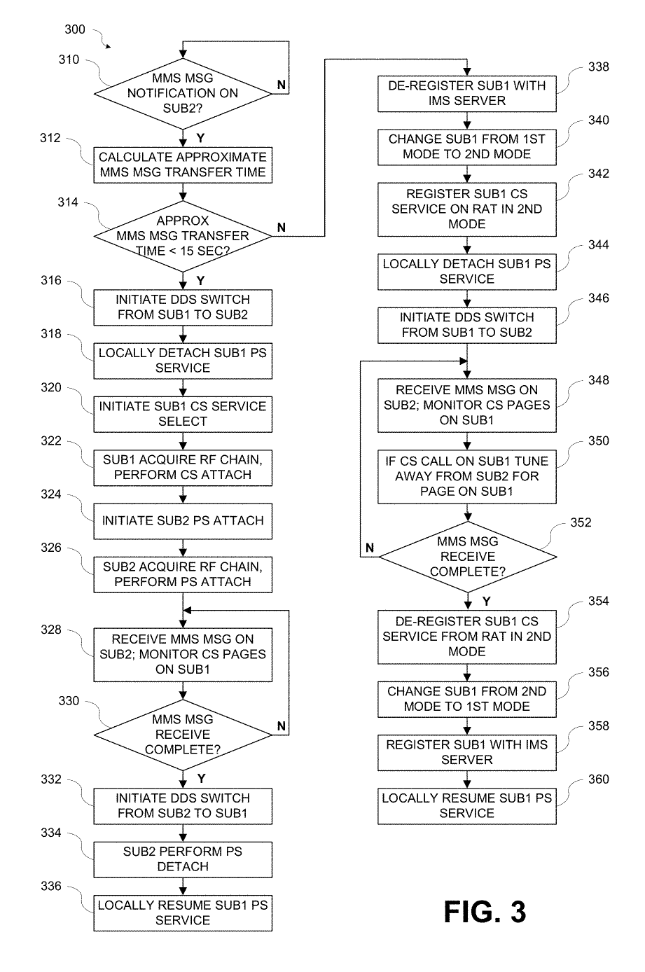

FIG. 3 is a flowchart illustrating a method 300 for performing data service switch for a mobile communication device having a first subscription configured as a DDS and a second subscription according to various embodiments.

The first subscription (Sub1 192) may be configured as a DDS with packet switched and circuit switched (PS+CS) service. For example, Sub1 192 may be configured with Long Term Evolution/Wideband Code Division Multiple Access/Global System for Mobile communications (LTE/WCDMA/GSM) capability and may be camped on LTE with PS+CS service. The second subscription (Sub2 197) may be configured as a CS-only (i.e., voice call) subscription. For example, Sub2 197 may be configured with GSM with only CS service.

For small data transfers for Sub2 197 (e.g., small MIMS message transmission or reception), the mobile communication device 100 may perform a PS service detach procedure locally (i.e., without informing the IMS core network of the PS detach and DDS switch) for Sub1 192 (e.g., LTE) on SIM1 140. The mobile communication device 100 may switch the DDS to Sub2 197 (e.g., GSM) on SIM2 150 for receiving incoming MMS notifications through short message service (SMS) over GSM. If the MMS message size is small (e.g., the MMS message can be transferred in less than 10 seconds), the DDS may switch back to Sub1 192 on SIM1 140 after the MMS message transfer is completed and the mobile communication device 100 may receive the SIP INVITE since the SIP INVITE Retry timer has not reached the 15 second time limit.

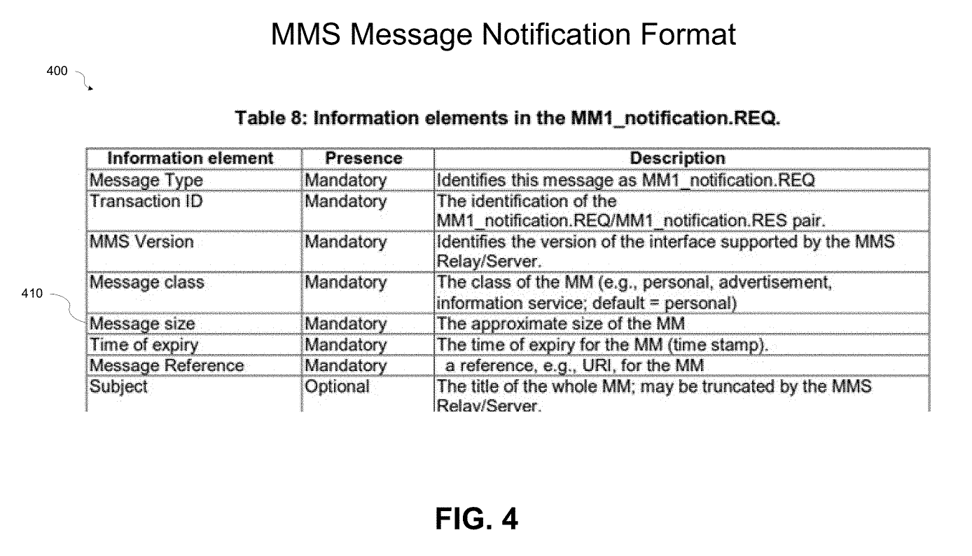

Referring to FIG. 3, at block 310, the control unit 110 may cause the RF chain 135 of the communication unit 120 to receive an MMS message notification on Sub2 197. At block 312, the control unit 110 of the mobile communication device 100 may calculate an approximate MMS message transfer time. The control unit 110 may calculate the approximate MMS message transfer time based on, for example, but not limited to, the MMS size parameter received in the MMS notification and the data transmission capability (e.g., packet data channel (PDCH) allocations, signal strength, etc.) of a corresponding communication network (e.g., the second communication network 195). FIG. 4 is a portion 400 of Table 8 from the MMS Functional Description specification (3GPP TS 23.140) illustrating the MMS message notification format including the message size parameter 410.

At block 314, the control unit 110 may determine if the approximate MMS message transfer time is less than a specified time. For example, the control unit 110 may determine if the approximate MMS message transfer time is less than fifteen seconds (or another time). If the control unit 110 determines that the approximate MMS message transfer time is less than the specified time (314-Y), at block 316 the control unit 110 may cause the communication unit 120 to initiate a DDS switch from Sub1 192 to Sub2 197.

At block 318, the control unit 110 may cause the communication unit 120 to locally detach the Sub1 192 PS service at the mobile communication device 100. In some embodiments, the control unit 110 may cause the communication unit 120 to locally detach the Sub1 192 PS service at the mobile communication device 100 without notifying a corresponding communication network (e.g., the first communication network 190). When the PS service for Sub1 192 is locally detached at the mobile communication device 100, the mobile communication device 100 does not send OTA messages to the corresponding communication network, for example an IMS core network (e.g., the first communication network 190) to notify the corresponding communication network that the Sub1 PS service has been detached. Therefore, any additional delay time resulting from overhead for the OTA messaging is avoided.

At block 320, the control unit 110 may cause the communication unit 120 to initiate the CS service attach procedure for the Sub1 192. At block 322, Sub1 192 may acquire the RF chain and may perform the CS service attach procedure with the corresponding communication network (e.g., the first communication network 190). At block 324, the control unit 110 may cause the communication unit 120 to initiate the PS service attach procedure for the Sub2 197. At block 326, Sub2 197 may acquire the RF chain and may perform the PS service attach procedure with the corresponding communication network (e.g., the second communication network 195).

In some embodiments, the control unit 110 may cause the communication unit 120 to complete the CS service attach procedure for Sub1 192 prior to initiating the PS service attach procedure for Sub2 197. For example, the control unit 110 may generate a signal to the communication unit 120 to indicate that the CS service attach procedure for Sub1 192 has completed.

In some embodiments the CS service attach procedure for Sub1 192 may be initiated before initiation of the PS service attach procedure for Sub2 197. For example, the control unit 110 may cause a timer (e.g., timing unit 112) to delay initiation of the PS service attach procedure for Sub2 197 to ensure that Sub1 192 gains control of the RF chain 135 to perform the CS service attach procedure prior to initiating the PS service attach procedure for Sub2 197. By enabling the CS service attach procedure prior to the PS service attach procedure, interruption of the CS service may be minimized.

After the DDS switch, Sub1 192 may be configured as the CS-only subscription capable of monitoring CS pages and/or conducting CS calls (i.e., voice calls) and Sub2 197 may be configured as the CS+PS DDS capable of receiving and/or transmitting MMS messages. At block 328, Sub2 197 may receive the MMS message and Sub1 192 may monitor CS pages.

At block 330, the control unit 110 may determine if reception of the MMS message is complete. If the control unit 110 determines that reception of the MMS message is not complete (330-N), the control unit 110 may cause the communication unit 120 to continue receiving the MMS message on Sub2 197 at block 328. If the control unit 110 determines that reception of the MMS message is complete (330-Y), at block 332 the control unit 110 may cause the communication unit 120 to initiate a DDS switch from Sub2 197 to Sub1 192.

At block 334, the control unit 110 may cause the communication unit 120 to detach the PS service for Sub2 197 from the corresponding communication network (e.g., the second communication network 195). At block 336, the control unit 110 may cause the communication unit 120 to locally resume the PS service for Sub1 192 at the mobile communication device 100.

When the PS service for Sub1 192 is locally resumed at the mobile communication device 100, the mobile communication device 100 does not send OTA messages to the corresponding communication network (e.g., the first communication network 190) to notify the corresponding communication network that the Sub1 PS service has been resumed. Therefore, any additional delay time resulting from overhead for the OTA messaging is avoided.

Returning now to block 314, if the control unit 110 determines that the approximate MMS message transfer time is not less than the specified time (314-N). For example, the control unit 110 may determine that the approximate MMS message transfer time is equal to or greater than fifteen seconds (or another time). At block 338, the control unit 110 may cause the communication unit 120 to deregister Sub1 192 with a corresponding IMS server (e.g., IMS server 165).

At block 340, the control unit 110 may cause the communication unit 120 to change a mode of Sub1 192 from a first mode to a second mode. For example, in the first mode for Sub1 192 a radio access technology (RAT) may be LTE, and in the second mode for Sub1 192 RATs may be GSM and WCDMA. One of ordinary skill in the art will appreciate that additional and/or different RATs may be included in the first and/or second modes for Sub1 192 without departing from the scope of this disclosure.

At block 342, the control unit 110 may cause the communication unit 120 to register Sub1 192 CS service on one of the RATs in the second mode with the corresponding communication network (e.g., the first communication network 190). For example, Sub1 192 may be registered for CS service on WCDMA.

At block 344, the control unit 110 may cause the communication unit 120 to locally detach the Sub1 192 PS service at the mobile communication device 100. In some embodiments, the control unit 110 may cause the communication unit 120 to locally detach the Sub1 192 PS service at the mobile communication device 100 without notifying a corresponding communication network (e.g., the first communication network 190). When the PS service for Sub1 192 is locally detached at the mobile communication device 100, the mobile communication device 100 does not send OTA messages to the corresponding communication network (e.g., the first communication network 190) to notify the corresponding communication network that the Sub1 PS service has been detached. Therefore, any additional delay time resulting from overhead for the OTA messaging is avoided.

At block 346 the control unit 110 may cause the communication unit 120 to initiate a DDS switch from Sub1 192 to Sub2 197. After the DDS switch Sub1 192 may be configured as the CS-only subscription capable of monitoring CS pages and/or conducting CS calls (i.e., voice calls), and Sub2 197 may be configured as the CS+PS DDS capable of receiving and/or transmitting MMS messages. At block 348, Sub2 197 may receive the MMS message and Sub1 192 may monitor CS pages. At block 350, if a CS call is received on Sub1 192, the control unit 110 may cause the communication unit 120 to tune away from GSM on Sub2 197 (i.e., the MMS message reception) to WCDMA on Sub1 192 to receive CS pages.

At block 352, the control unit 110 may determine if reception of the MMS message is complete. If the control unit 110 determines that reception of the MMS message is not complete (352-N), the control unit 110 may cause the communication unit 120 to continue receiving the MMS message on Sub2 197 at block 348. If the control unit 110 determines that reception of the MMS message is complete (352-Y), at block 354, the control unit 110 may cause the communication unit 120 to deregister the Sub1 192 CS service on the one of the RATs in the second mode with the corresponding communication network (e.g., the first communication network 190). For example, the control unit 110 may cause the communication unit 120 to deregister the Sub1 192 CS service on WCDMA.

At block 356, the control unit 110 may cause the communication unit 120 to change a mode of Sub1 192 from a second mode to a first mode. For example, in the second mode for Sub1 192 RATs may be GSM and WCDMA, and in the first mode for Sub1 192 a RAT may be LTE. One of ordinary skill in the art will appreciate that additional and/or different RATs may be included in the first and/or second modes for Sub1 192 without departing from the scope of this disclosure.

At block 358, the control unit 110 may cause the communication unit 120 to register Sub1 192 with a corresponding IMS server (e.g., IMS server 165), and at block 360, the control unit 110 may cause the communication unit 120 to locally resume the PS service for Sub1 192 at the mobile communication device 100.

When the PS service for Sub1 192 is locally resumed at the mobile communication device 100, the mobile communication device 100 does not send OTA messages to the corresponding communication network (e.g., the first communication network 190) to notify the corresponding communication network that the Sub1 PS service has been resumed. Therefore, any additional delay time resulting from overhead for the OTA messaging is avoided.

The method 300 may be embodied on a non-transitory computer readable medium, for example, but not limited to, the storage unit 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined by reference to the appended claims.

What is claimed is:

1. A method for performing data service switch for a mobile communication device having a first subscription configured as a dedicated data subscription (DDS) and a second subscription, the method comprising:
receiving a multimedia messaging service (MMS) message notification on the second subscription;
calculating an approximate transfer time for receiving an MMS message;
determining that the approximate transfer time is less than a specified time;
in response to determining that the approximate transfer time is less than the specified time, performing at the mobile communication device a local packet switched (PS) service detach procedure for the first subscription;
performing a circuit switched (CS) service attach procedure for the first subscription; and
performing a PS service attach procedure for the second subscription.

2. The method of claim 1, wherein the approximate transfer time is calculated based on at least a message size indicated in the MMS message notification and a data transmission capability of a corresponding communication network.

3. The method of claim 1, wherein the local PS service detach procedure comprises detaching the PS service at the mobile communication device without notifying a corresponding communication network.

4. The method of claim 1, wherein the CS service attach procedure for the first subscription is completed before the PS service attach procedure for the second subscription is initiated.

5. The method of claim 1, wherein the CS service attach procedure for the first subscription is initiated before the PS service attach procedure for the second subscription is initiated.

6. The method of claim 5, wherein initiating the PS service attach procedure for the second subscription is delayed for a time period following initiation of the CS service attach procedure for the first subscription.

7. The method of claim 6, wherein the time period is determined by a timing unit.

8. The method of claim 1, further comprising:
determining that the approximate transfer time is equal to or greater than the specified time;
in response to determining that the approximate transfer time is equal to or greater than the specified time:
deregistering the first subscription from an Internet Protocol (IP) Multimedia Subsystem (IMS) server;
changing a mode of the first subscription from a first mode to a second mode;
registering the CS service for the first subscription in the second mode with a mobile switching center (MSC); and
performing at the mobile communication device the local PS service detach procedure for the first subscription.

9. The method of claim 8, wherein the approximate transfer time is calculated based on at least a message size indicated in the MMS message notification and a data transmission capability of a corresponding communication network.

10. The method of claim 8, wherein the local PS service detach procedure comprises detaching the PS service at the mobile communication device without notifying a corresponding communication network.

11. A mobile communication device having a first subscription configured as a dedicated data subscription (DDS) and a second subscription, the mobile communication device comprising:
a communication unit;
a radio frequency (RF) chain; and
a control unit configured to:
control the communication unit to receive a multimedia messaging service (MMS) message notification on the second subscription via the RF chain;
calculate an approximate transfer time for receiving an MMS message;
determine that the approximate transfer time is less than a specified time;
in response to determining that the approximate transfer time is less than the specified time, the control unit is configured to perform at the mobile communication device a local packet switched (PS) service detach procedure for the first subscription;
perform a circuit switched (CS) service attach procedure for the first subscription; and
perform a PS service attach procedure for the second subscription.

12. The mobile communication device of claim 11, wherein the control unit is configured to calculate the approximate transfer time based on at least a message size indicated in the MMS message notification and a data transmission capability of a corresponding communication network.

13. The mobile communication device of claim 11, wherein the control unit is configured to perform the local PS service detach procedure at the mobile communication device without notifying a corresponding communication network.

14. The mobile communication device of claim 11, wherein the control unit configured to cause the CS service attach procedure for the first subscription to complete before initiating the PS service attach procedure for the second subscription.

15. The mobile communication device of claim 11, wherein the control unit configured to cause initiation of the CS service attach procedure for the first subscription before initiation of the PS service attach procedure for the second subscription.

16. The mobile communication device of claim 15, further comprising:
a timing unit,
wherein the control unit configured to delay initiation of the PS service attach procedure for the second subscription for a time period following initiation of the CS service attach procedure for the first subscription, and
wherein the time period is determined by the timing unit.

17. The mobile communication device of claim 11, wherein:
the control unit is configured to determine that the approximate transfer time is equal to or greater than the specified time;
in response to determining that the approximate transfer time is equal to or greater than the specified time, the control unit is configured to:
deregister the first subscription from an Internet Protocol (IP) Multimedia Subsystem (IMS) server;
cause the communication unit to change a mode of the first subscription from a first mode to a second mode;
register the CS service for the first subscription in the second mode with a mobile switching center (MSC); and
perform at the mobile communication device the local PS service detach procedure for the first subscription.

18. The mobile communication device of claim 17, wherein the control unit calculates the approximate transfer time based on at least a message size indicated in the MMS message notification and a data transmission capability of a corresponding communication network.

19. The mobile communication device of claim 17, wherein the control unit is configured to perform the local PS service detach procedure at the mobile communication device without notifying a corresponding communication network.

20. The mobile communication device of claim 11, wherein the RF chain comprises an antenna and an RF module, and
wherein the RF module comprises a transceiver.

21. A non-transitory computer readable medium having stored therein a program for causing one or more processors to execute a method for performing data service switch for a mobile communication device having a first subscription configured as a dedicated data subscription (DDS) and a second subscription, said program including computer executable instructions for performing operations comprising:
receiving a multimedia messaging service (MMS) message notification on the second subscription;
calculating an approximate transfer time for receiving an MMS message;
determine that the approximate transfer time is less than a specified time;
in response to determining that the approximate transfer time is less than the specified time, performing at the mobile communication device a local packet switched (PS) service detach procedure for the first subscription;
performing a circuit switched (CS) service attach procedure for the first subscription; and
performing a PS service attach procedure for the second subscription.

22. The non-transitory computer readable medium having stored therein a program as defined in claim 21, the program further comprising instructions to perform operations comprising:
calculating the approximate transfer time based on at least a message size indicated in the MMS message notification and a data transmission capability of a corresponding communication network.

23. The non-transitory computer readable medium having stored therein a program as defined in claim 21, the program further comprising instructions to perform operations comprising:
performing the local PS service detach procedure by detaching the PS service at the mobile communication device without notifying a corresponding communication network.

24. The non-transitory computer readable medium having stored therein a program as defined in claim 21, the program further comprising instructions to perform operations comprising:
completing the CS service attach procedure for the first subscription before initiating the PS service attach procedure for the second subscription.

25. The non-transitory computer readable medium having stored therein a program as defined in claim 21, the program further comprising instructions to perform operations comprising:
initiating the CS service attach procedure for the first subscription before initiating the PS service attach procedure for the second subscription.

26. The non-transitory computer readable medium having stored therein a program as defined in claim 21, the program further comprising instructions to perform operations comprising:
delaying initiation of the PS service attach procedure for the second subscription for a time period following initiation of the CS service attach procedure for the first subscription.

27. The non-transitory computer readable medium having stored therein a program as defined in claim 21, the program further comprising instructions to perform operations comprising:
determining the time period with a timing unit.

28. The non-transitory computer readable medium having stored therein a program as defined in claim 21, the program further comprising instructions to perform operations comprising:
determining that the approximate transfer time is equal to or greater than the specified time;
in response to determining that the approximate transfer time is equal to or greater than the specified time:
deregistering the first subscription from an Internet Protocol (IP) Multimedia Subsystem (IMS) server;
changing a mode of the first subscription from a first mode to a second mode;
registering the CS service for the first subscription in the second mode with a mobile switching center (MSC); and
performing at the mobile communication device the local PS service detach procedure for the first subscription.

29. A mobile communication device having a first subscription configured as a dedicated data subscription (DDS) and a second subscription, the mobile communication device comprising:
means for receiving a multimedia messaging service (MMS) message notification on the second subscription;
means for calculating an approximate transfer time for receiving an MMS message;
means for determining that the approximate transfer time is less than a specified time;
in response to determining that the approximate transfer time is less than the specified time, means for performing at the mobile communication device a local packet switched (PS) service detach procedure for the first subscription;
means for performing a circuit switched (CS) service attach procedure for the first subscription; and
means for performing a PS service attach procedure for the second subscription.

30. The mobile communication device of claim 29, further comprising:
means for determining that the approximate transfer time is equal to or greater than the specified time;
in response to determining that the approximate transfer time is equal to or greater than the specified time:
means for deregistering the first subscription from an Internet Protocol (IP) Multimedia Subsystem (IMS) server;
means for changing a mode of the first subscription from a first mode to a second mode;
means for registering the CS service for the first subscription in the second mode with a mobile switching center (MSC); and
means for performing at the mobile communication device the local PS service detach procedure for the first subscription.
